(19) United States
(12) Patent Application Publication
(10) Pub. No.: US 2026/0080361 A1
(43) Pub. Date: Mar. 19, 2026

(54) INFORMATION PROCESSING DEVICE, INFORMATION PROCESSING METHOD, AND NON-TRANSITORY COMPUTER READABLE STORAGE MEDIUM

(71) Applicant: LY Corporation, Tokyo (JP)

(72) Inventor: Yuta MATSUDA, Tokyo (JP)

(21) Appl. No.: 19/297,989

(22) Filed: Aug. 12, 2025

(30) Foreign Application Priority Data
Sep. 19, 2024 (JP) 2024-162049

(51) Int. Cl. G06Q 10/10

(52) U.S. Cl. CPC G06Q 10/10

(57) ABSTRACT

An information processing device according to the present application includes: an acquisition unit that acquires business operator information of a business operator; an estimation unit that estimates a proposal service to be proposed from among a plurality of services based on the business operator information; a generation unit that generates explanatory content describing a use mode when the business operator uses the proposal service; and a provision unit that provides the explanatory content.

### CROSS-REFERENCE TO RELATED APPLICATIONS

The present application claims priority to and incorporates by reference the entire contents of Japanese Patent Application No. 2024-162049 filed in Japan on Sep. 19, 2024.

### BACKGROUND OF THE INVENTION

### 1. Field of the Invention

The present invention relates to an information processing device, an information processing method, and a non-transitory computer readable storage medium.

### 2. Description of the Related Art

There has been disclosed a system that suppresses loss of a store by providing a privilege, a point, or the like to a customer (see JP 6474577 B2).

However, there is room for improvement in the related art described above. For example, in the related art described above, a service execution time or the like is not appropriately proposed to a business operator (store). Therefore, it is required to appropriately propose a service to a business operator.

### SUMMARY OF THE INVENTION

It is an object of the present invention to at least partially solve the problems in the conventional technology.

An information processing device includes an acquisition unit that acquires business operator information of a business operator, an estimation unit that estimates a proposal service to be proposed from among a plurality of services based on the business operator information, a generation unit that generates explanatory content describing a use mode when the business operator uses the proposal service, and a provision unit that provides the explanatory content.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating an overview of an information processing system according to an embodiment;

FIG. 2 is a diagram illustrating a configuration example of a server device according to the embodiment;

FIG. 3 is a diagram illustrating a display example of a proposal result provided by the server device;

FIG. 4 is a flowchart illustrating a processing procedure according to the embodiment; and

FIG. 5 is a diagram illustrating an example of a hardware configuration.

### DETAILED DESCRIPTION OF THE PREFERRED EMBODIMENTS

Modes (hereinafter referred to as “embodiments”) for implementing an information processing device, an information processing method, and a non-transitory computer readable storage medium according to the present application will be described in detail below with reference to the drawings. Note that the information processing device, the information processing method, and the information processing program according to the present application are not limited by the embodiments. In addition, in the following embodiments, the same portions are denoted by the same reference numerals, and redundant description thereof will be omitted.

### 1. Overview of Information Processing System

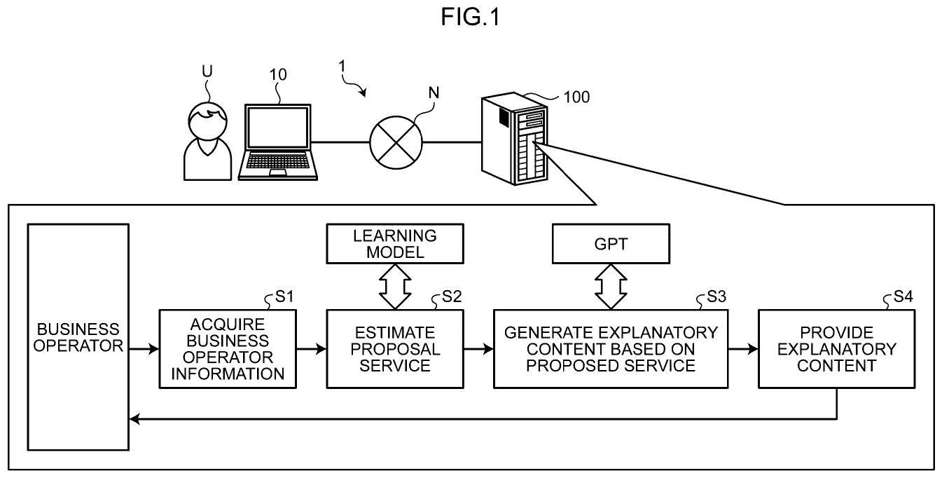

An overview of an information processing system according to the embodiment will be first described with reference to FIG. 1. FIG. 1 is an explanatory diagram illustrating the overview of the information processing system according to the embodiment. As illustrated in FIG. 1, an information processing system 1 according to the embodiment includes a terminal device 10 and a server device 100. These various devices are communicably connected to each other in a wired or wireless manner via a network N. Thus, the terminal device 10 can link with the server device 100. The network N is, for example, a local area network (LAN), a wide area network (WAN), the Internet, or the like. The terminal device 10 represents a personal computer (PC), but may be another equipment such as a smartphone or a tablet terminal.

The server device 100 is, for example, a computer such as a PC or a blade server, or a mainframe, a workstation, or the like. Note that the server device 100 may be implemented by cloud computing.

In the present embodiment, the server device 100 is an information processing device that links with the terminal device 10 of each business operator U and that provides, to the terminal device 10 of each business operator U, an application programming interface (API) service or the like for various applications (hereinafter referred to as apps) or the like, and various types of data, and is implemented by a computer, a cloud system, or the like. In the present embodiment, the business operator U preferably has a business operator account of a messaging app.

In addition, the server device 100 may be an information processing device that provides some kind of online service to the terminal device 10 of each business operator U. For example, the server device 100 may provide, as the online service, services such as Internet connection, a search service, a chat service, an interaction service using a voice, an image, a video, and the like, a social networking service (SNS), electronic commerce (EC), electronic payment, an online game, online banking, online trading, accommodation/ticket reservation, video/music distribution, news, a map, route search, route guidance, route information, operation information, and weather forecast. In practice, the server device 100 may link with various servers that provide the online service as described above to mediate the online service, or may be in charge of processing of the online service.

The server device 100 acquires, from the terminal device 10 of the business operator U, or from various servers or the like based on a business operator ID or the like, business operator information. For example, the server device 100 acquires various types of history information (log data) indicating the behavior of the business operator U. For example, the server device 100 acquires a position history, which is a history of the position and the date and time of the business operator U, from the terminal device 10. The server device 100 acquires an advertisement provision history of the business operator U. For example, the server device 100 acquires a history in which the business operator U has provided an advertisement to an advertising agency. In addition, the server device 100 acquires a use history of various services of the business operator U. For example, the server device 100 acquires a search history of the business operator U, which is a history of search queries input by the business operator U, from a search server (search engine). In addition, the server device 100 acquires a browsing history, which is a history of content browsed by the business operator U, from a content server. In addition, the server device 100 acquires a purchase history (payment history), which is a history of product purchase and payment processing of the business operator U, from an electronic commerce server or a payment processing server. In addition, the server device 100 may acquire a listing history or a sales history, which is a history of listing on the marketplace of the business operator U, from an electronic commerce server or a payment processing server. In addition, the server device 100 acquires a posting history, which is a history of posting by the business operator U, from a posting server or an SNS server that provides a word-of-mouth posting service. In addition, the server device also acquires a preference log (which content is preferred, which of two similar responses is selected) of the content or the like of the business operator. In addition, the server device also acquires the reason for the preference or avoidance. Note that the various servers and the like described above may be the server device 100 itself. In other words, the server device 100 may function as the various servers and the like described above. Note that the business operator information includes, for example, a location of the business operator U, a business type, business contents, various services, financial information, input information input by the business operator U, and the like, in addition to the log data. The business operator information is not limited thereto.

In addition, the server device 100 can acquire user information on a user who uses the business operator U. For example, the server device 100 acquires, as the user information, information (attribute information) related to attributes of the user such as the gender, age, and residential area of the user. In addition, the server device 100 can acquire information regarding attributes such as demographic (demographic attributes), psychographic (psychological attributes), geographic (geographical attributes), and behavior (behavioral attributes) of the user. In addition, the server device 100 may acquire, as the user information, a segment, a persona (image of a person), or the like to which the user belongs in the field of marketing. The server device 100 then stores and manages identification information (user ID or the like) indicating the user and information (attribute information) regarding the attribute of the user.

In addition, the number of each of the devices included in the information processing system 1 illustrated in FIG. 1 is not limited to that illustrated in the drawing. For example, in FIG. 1, only one terminal device 10 is illustrated for simplicity of illustration of the drawings, but this is merely an example, and the number of terminal devices is not limited thereto, and may be two or more.

### 2. Provision of Explanatory Content

Under the current circumstances, it is difficult for a business operator to find an issue and propose a solution. For example, with regard to finding an issue and providing a solution, a sales representative performs analysis in consideration of a year-over-year (YoY: ratio to the previous year), a distribution progress, a category share, a trend, and the like, and examines an issue, a solution, and the like that are likely to increase, but the sales representative may or may not be able to appropriately identify the identification of the issue, the proposal of the solution, and the like, and thus the identification of the issue and the proposal of the solution are person-dependent. In addition, for example, it is often difficult for a small or medium-sized business operator to have a sales representative in terms of funding or the like, and the small or medium-sized business operator cannot find an issue or know a solution, and has a problem in management such as a desire to increase sales or difficulty in growth of business results.

In addition, there is a problem in that an appropriate past proposal is not found or a past proposal is lost even if a sales representative is assigned.

Therefore, information of the business operator U is acquired by using generative artificial intelligence (AI), and proposal of a solution is automated. The generative AI includes, for example, large language models (LLMs). In the present embodiment, a generative pre-trained transfer (GPT) among LLMs will be described as an example. The GPT is a text generation AI, and is a language model capable of generating sentences using natural languages.

For example, as illustrated in FIG. 1, the server device 100 receives business operator information from a business operator and acquires information (step S1). For example, the server device 100 acquires business operator information from the terminal device 10 of the business operator U via the network N. For example, the server device 100 acquires a sentence input by the business operator U as input information (business operator information) from the terminal device 10 of the business operator U via the network N. Note that the sentence may be manually input or may be input by voice. Alternatively, the sentence may be selected from existing sentences (sentence candidates). For example, the sentences to be input by the business operator U include a business type of the business operator U, a service already being performed, an issue of the business operator U, a budget for the issue, and a service already being performed by the business operator U.

The server device 100 then estimates a service to be proposed from among a plurality of services based on the received information (step S2). For example, the server device 100 estimates a service to be proposed based on the acquired business operator information (e.g., an advertisement provision history or a use history of various services). For example, the server device 100 estimates a service to be proposed based on input information (budget or the like) input by the business operator U. The server device 100 estimates a service to be proposed by inputting the received information to a learning model. The plurality of services includes, for example, operation of an official account of the business operator U for SNS, provision of an app (mini app) of a business operator official account in a messaging app, delivery of an advertisement, mail order, electronic payment, coupons, and the like. The mini app is, for example, an application that is displayed on the lower side of a screen for transmitting and receiving messages to and from a business operator account, and that has a function of presenting a membership card, a function of providing product information to a user, and the like. Note that the plurality of services is not limited thereto.

The learning model is a model that has learned a set of business operator information of the business operator U, characteristics before and after provision of a past service, and a budget at that time. The learning model is a model in which learning is performed such that, when information of the business operator U received by the server device 100 is input, a service corresponding to the information is proposed and output as a proposal service. For example, the learning model is a model in which learning is performed to output a proposal service having high similarity to business operator information (close to the business operator information of the business operator U) based on the information of the business operator U received by the server device 100. For example, when the log data of the business operator U is input to the learning model, the learning model outputs a proposal service having high similarity to business operator information based on the information. For example, when input information input by the business operator U is input to the learning model, the learning model outputs a proposal service having high similarity to business operator information based on the information. The learning model outputs a plurality of proposal services having high similarity to business operator information. For example, the learning model may output a combination of proposal services having high similarity to business operator information. Here, characteristics before and after provision of a past service include a change in sales, a change in the number of customers visiting stores, and the like, and include not only a case where these changes increase but also a case where these changes decrease.

In addition, the learning model may learn not to propose a service whose sales are reduced when the information of the business operator U is input. In addition, the learning model may learn to switch the service when the information of the business operator U is input. For example, when the information of the business operator U is input, the learning model estimates whether or not the sales of the business operator U will be reduced, and in a case where it is estimated that the sales of the business operator U will be reduced, the learning model may not output the service of which the sales will be reduced or may output the service so as to switch the service already being performed.

Note that the learning model may learn a set of business operator information of a business operator similar to the business operator U, characteristics before and after provision of a past service of the business operator similar to the business operator U, and a budget of the service.

The server device 100 then generates explanatory content (explanatory sentence) based on the estimated proposal service (step S3). For example, the server device 100 outputs the estimated proposal service to the GPT and acquires the detailed explanatory content generated by the GPT. For example, the server device 100 inputs the business operator information of the business operator U, and the function (the discount rate of the coupon or the like) and the description (the time at which the coupon is distributed or the like) of the proposal service estimated in the business operator U to the GPT, and generates the explanatory content describing the use mode when the business operator U uses the proposed service. The server device 100 generates the explanatory content in consideration of the service already being performed by the business operator U in the GPT.

The GPT generates explanatory content that specifically describes the proposed service. The GPT generates the explanatory content so as to include an execution period of the proposed service (from when to when, all year, or the like), a specific numerical value (e.g., a discount rate of a coupon), and the like. For example, the GPT generates explanatory content describing an effect at that time based on the proposed service. For example, the GPT generates the explanatory content in consideration of a service already being performed by the business operator U.

The server device 100 then provides the generated explanatory content to the business operator (step S4). For example, the server device 100 provides the generated explanatory content as a proposed service to the terminal device 10 of the business operator U via the network N. At this point, the server device 100 may provide the generated explanatory content to the terminal device 10 of the business operator U through a user interface (UI). In other words, the server device 100 may cause the UI to display the generated explanatory content. The server device 100 may provide the generated explanatory content to the terminal device 10 of the business operator U by mail via the network N. In the present embodiment, the UI is a unified management system to be described later.

### 3. Configuration Example of Server Device

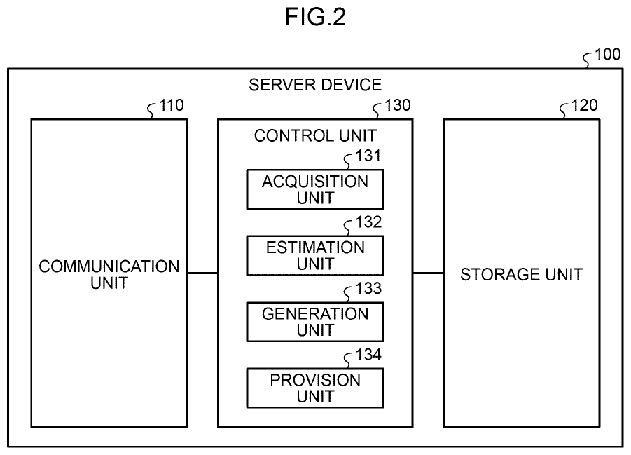

A configuration of the server device 100 according to the embodiment will now be described with reference to FIG. 2. FIG. 2 is a diagram illustrating a configuration example of the server device 100 according to the embodiment. As illustrated in FIG. 2, the server device 100 includes a communication unit 110, a storage unit 120, and a control unit 130.

### Communication Unit 110

The communication unit 110 is implemented by, for example, a network interface card (NIC). The communication unit 110 is connected to the network N in a wired or wireless manner.

### Storage Unit 120

The storage unit 120 is implemented by, for example, a semiconductor memory element such as a random access memory (RAM) or a flash memory, or a storage device such as an HDD, an SSD, or an optical disk. The storage unit 120 may store attribute information or history information (log data) of the business operator U together with identification information (business operator ID or the like) indicating the business operator U.

### Control Unit 130

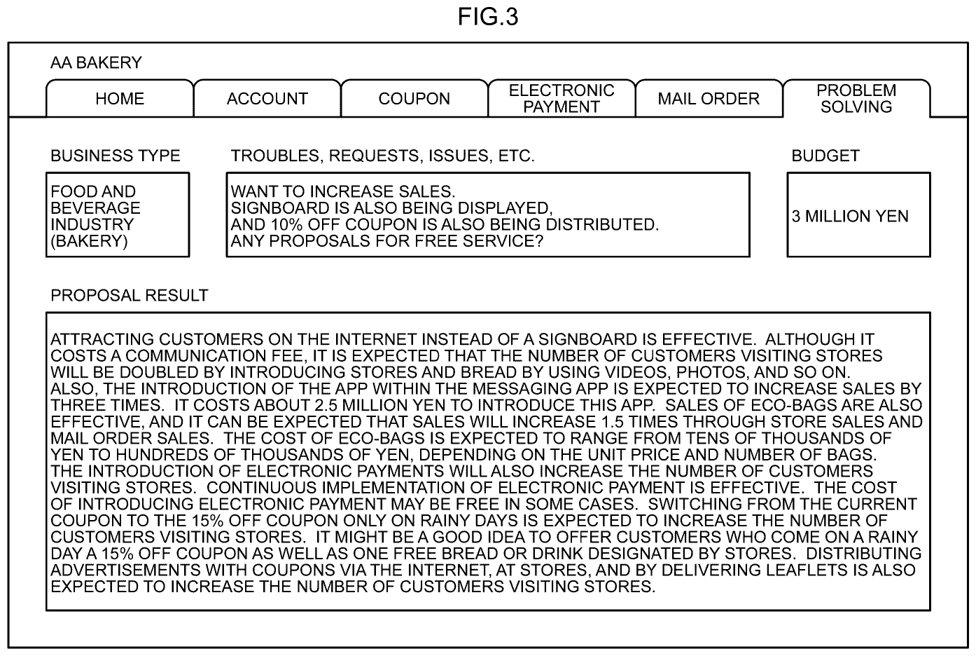

The control unit 130 is a controller (controller) and is implemented by, for example, a graphics processing unit (GPU), a central processing unit (CPU), a micro processing unit (MPU), an application specific integrated circuit (ASIC), a field programmable gate array (FPGA), or the like executing various programs (corresponding to an example of a non-transitory computer readable storage medium) stored in an internal storage device of the server device 100 using a storage area such as a RAM as a work area. In the example illustrated in FIG. 3, the control unit 130 has an acquisition unit 131, an estimation unit 132, a generation unit 133, and a provision unit 134.

### Acquisition Unit 131

The acquisition unit 131 acquires business operator information related to the business operator U via the communication unit 110. For example, the acquisition unit 131 acquires, from the terminal device 10 of the business operator U, identification information (business operator ID or the like) indicating the business operator U, position information of the business operator U, attribute information of the business operator U, and the like. The acquisition unit 131 then stores the business operator information in the storage unit 120. In addition, the acquisition unit 131 may acquire identification information, attribute information, or the like which is user information of a user who uses the business operator U. The acquisition unit 131 then stores the user information in the storage unit 120.

In addition, the acquisition unit 131 acquires input information input by the business operator U. For example, the acquisition unit 131 acquires business operator information via the communication unit 110 when the business operator U performs input to the UI. In other words, the acquisition unit 131 acquires a keyword or a sentence input to the UI by the business operator U via the communication unit 110. The acquisition unit 131 then stores the input information in the storage unit 120.

In addition, the acquisition unit 131 acquires various types of history information (log data) indicating the behavior of the business operator U via the communication unit 110. For example, the acquisition unit 131 acquires, from the terminal device 10 of the business operator U, or from various servers or the like based on the business operator ID or the like, various types of history information indicating the behavior of the business operator U. The acquisition unit 131 then stores the various types of history information in the storage unit 120.

### Estimation Unit 132

The estimation unit 132 estimates a proposal service to be proposed from among a plurality of services based on the business operator information. For example, the estimation unit 132 estimates a proposal service to be proposed from among a plurality of services based on the business operator information acquired by the acquisition unit 131. For example, the estimation unit 132 estimates a proposal service to be proposed from among a plurality of services based on input information input by the business operator U by accessing the unified management system. The estimation unit 132 may propose switching of a service already being performed by the business operator U. The estimation unit 132 may estimate whether or not the sales of the business operator U will be reduced, and may estimate the proposal service. For example, the estimation unit 132 may estimate whether or not the sales of the business operator U will be reduced, and may propose switching of the service if the sales of the business operator U will be reduced. In addition, for example, the estimation unit 132 may estimate whether or not the sales of the business operator U will be reduced, and may not propose a service in which the sales will be reduced.

At this point, the estimation unit 132 estimates a proposal service having high similarity to business operator information by using the learning model.

### Generation Unit 133

The generation unit 133 generates explanatory content describing the use mode when the business operator U uses the proposal service. The generation unit 133 inputs the business operator information of the business operator U and the function and the description of the proposal service estimated by the estimation unit 132 in the business operator U to the GPT, and generates the explanatory content describing the use mode when the business operator U uses the proposed service. The generation unit 133 generates the explanatory content in consideration of the service already being performed by the business operator U.

At this point, the generation unit 133 generates the explanatory content by using the GPT.

### Provision Unit 134

The provision unit 134 provides the unified management system to the business operator U. The provision unit 134 provides the generated explanatory content to the business operator U. For example, the provision unit 134 provides the unified management system to the terminal device 10 of the business operator U via the communication unit 110. For example, the provision unit 134 provides the generated explanatory content to the terminal device 10 of the business operator U via the unified management system. In other words, the provision unit 134 may cause the unified management system to display the generated explanatory content. The provision unit 134 may provide the explanatory content to the business operator by transmitting a mail. The provision unit 134 may use a different providing method for each business operator U. The provision unit 134 may use a different providing method depending on the generated explanatory content. For example, the provision unit 134 may provide the simple explanatory content to the business operator U by mail.

A screen display example of the terminal device 10 of the business operator U provided by the provision unit 134 will now be described with reference to FIG. 3. FIG. 3 is a diagram illustrating the screen display example. FIG. 3 illustrates an example of the unified management system.

The unified management system is a system for setting and confirming services of the business operator U. When the business operator U accesses the unified management system, the business operator U can set and confirm a service linked by the business operator U, for example, by switching a tab. As illustrated in FIG. 3, in the unified management system, “home”, “account”, “coupon”, “electronic payment”, “mail order”, and “problem solving” tabs are illustrated. For example, when the business operator U selects the “coupon” tab, the business operator U can view information related to a coupon. The unified management system is preferably, for example, a dashboard. For example, the unified management system displays in advance a tab of a service to which the business operator U can be linked, and when the business operator U selects a tab of a service to which the business operator U is not linked, the unified management system displays that the service is not linked. The unified management system may increase the number of tabs of linked services each time the business operator U newly links a service. Note that the tabs are not limited to the above example. In addition, the unified management system is not limited to switching and displaying tabs.

In addition, FIG. 3 illustrates a display example of a proposal result provided by the server device 100. As illustrated in FIG. 3, when the business operator U selects the “problem solving” tab, the server device 100 displays an input screen of the unified management system. The acquisition unit 131 acquires business operator information (input information) input to the unified management system by the business operator U, and the estimation unit 132 estimates a service based on the acquired business operator information and outputs a proposal service to the generation unit 133. The generation unit 133 generates a sentence based on the proposal service and outputs the generated sentence to the provision unit 134. The provision unit 134 displays the generated sentence as a proposal result. In FIG. 3, an example is illustrated in which the business operator U inputs, on the display screen of the terminal device 10, “food and beverage industry (bakery)” in the “business type”, inputs “Want to increase sales. A signboard is also being displayed, and a 10% off coupon is also being distributed. Any proposals for free service?” in the “troubles, requests, issues, etc.” (hereinafter referred to as requests), and inputs “3 million yen” in the “budget”, as business operator information. For example, the provision unit 134 displays, in the “proposal result”, the following: “Attracting customers on the Internet instead of a signboard is effective. Although it costs a communication fee, it is expected that the number of customers visiting stores will be doubled by introducing stores and bread by using videos, photos, and so on. Also, the introduction of the app within the messaging app is expected to increase sales by three times. It costs about 2.5 million yen to introduce this app. Sales of eco-bags are also effective, and it can be expected that sales will increase 1.5 times through store sales and mail order sales. The cost of eco-bags is expected to range from tens of thousands of yen to hundreds of thousands of yen, depending on the unit price and number of bags. The introduction of electronic payments will also increase the number of customers visiting stores. Continuous implementation of electronic payment is effective. The cost of introducing electronic payment may be free in some cases. Switching from the current coupon to the 15% off coupon only on rainy days is expected to increase the number of customers visiting stores. It might be a good idea to offer customers who come on a rainy day a 15% off coupon as well as one free bread or drink designated by stores. Distributing advertisements with coupons via the Internet, at stores, and by delivering leaflets is also expected to increase the number of customers visiting stores.” The server device 100 may provide the explanatory content displayed by the unified management system by mail. In addition, the server device 100 may output a proposal result at least when the business operator U inputs the business type and the budget. In other words, the request of the business operator U may not be input.

Note that the contents illustrated in FIG. 3 are an example for illustrating specific contents, and the actual contents are not necessarily as illustrated in FIG. 3.

### 4. Processing Procedure

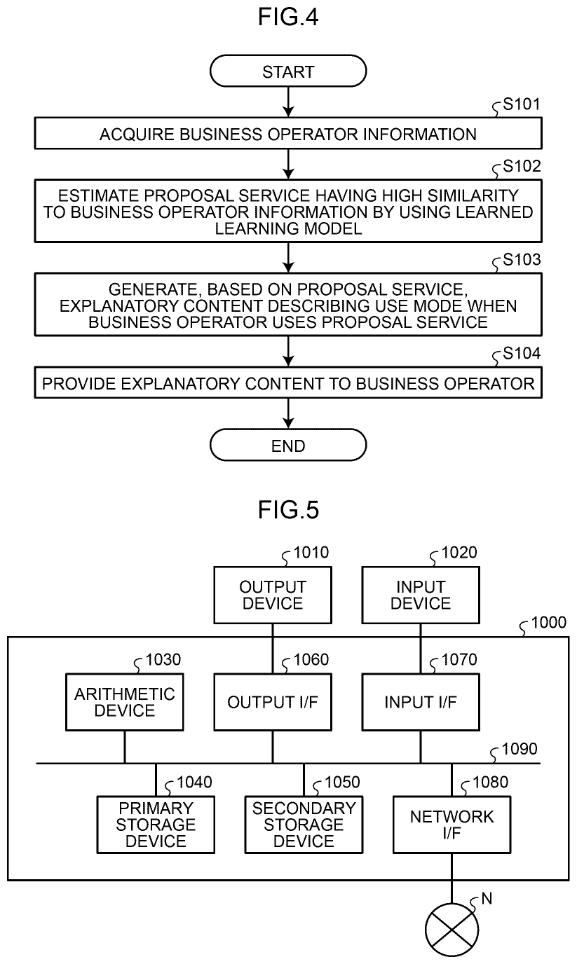

A processing procedure performed by the server device 100 according to the embodiment will now be described with reference to FIG. 4. FIG. 4 is a flowchart illustrating the processing procedure according to the embodiment. Note that the processing procedure described below is repeatedly executed by the control unit of the server device 100.

For example, as illustrated in FIG. 4, the acquisition unit 131 of the server device 100 acquires business operator information from the terminal device 10 of the business operator U via the communication unit 110 (step S101).

Subsequently, the estimation unit 132 of the server device 100 estimates a proposal service having high similarity to business operator information by using the learned learning model (step S102).

Subsequently, the generation unit 133 of the server device 100 generates, based on the proposal service, explanatory content describing a use mode when the business operator uses the service, by using the GPT (step S103).

Subsequently, the provision unit 134 of the server device 100 provides the explanatory content to the business operator via the communication unit 110 (step S104).

### 5. Modification

The terminal device 10 and the server device 100 described above may be implemented in various different forms other than the above-described embodiment. Therefore, a modification of the embodiment will be described below.

In the above-described embodiment, some or all of the processes executed by the server device 100 may be actually executed by the terminal device 10 (or an app operating on the terminal device 10). For example, the processes may be completed in a stand-alone manner (by the terminal device 10 alone). In this case, it is assumed that the terminal device 10 has the function of the server device 100 in the above-described embodiment. In addition, in the above-described embodiment, since the terminal device 10 links with the server device 100, it appears to the business operator U that the processes of the server device 100 are also executed by the terminal device 10. In other words, from another viewpoint, it can be said that the terminal device 10 includes the server device 100.

### 6. Effect

As described above, the information processing devices (the terminal device 10 and the server device 100) according to the present application include: the acquisition unit 131 that acquires business operator information of a business operator; the estimation unit 132 that estimates a proposal service to be proposed from among a plurality of services based on the business operator information; the generation unit 133 that generates explanatory content describing a use mode when the business operator U uses the proposal service; and the provision unit 134 that provides the explanatory content.

The estimation unit 132 estimates the proposal service having high similarity to business operator information by using a learning model that has learned a set of business operator information, characteristics before and after provision of a past service, and a budget of the past service.

The estimation unit 132 proposes switching of a service already being performed by the business operator.

The estimation unit 132 estimates whether or not the sales of the business operator will be reduced, and estimates the proposal service.

The generation unit 133 inputs the business operator information and the function and description of the proposal service in the business operator to the GPT and generates explanatory content.

The generation unit 133 generates the explanatory content in consideration of the service already being performed by the business operator.

The provision unit 134 provides a unified management system for setting and confirming a service of the business operator, and provides the explanatory content through the unified management system.

The provision unit 134 provides the explanatory content to the business operator by mail.

By any one or a combination of the above-described processes, the information processing device according to the present application can appropriately propose a service to a business operator.

### 7. Hardware Configuration

In addition, the terminal device 10 and the server device 100 according to the above-described embodiment are implemented by a computer 1000 having a configuration as illustrated in FIG. 5, for example. The server device 100 will be described below as an example. FIG. 5 is a diagram illustrating an example of a hardware configuration. The computer 1000 is connected to an output device 1010 and an input device 1020, and has a form in which an arithmetic device 1030, a primary storage device 1040, a secondary storage device 1050, an output interface (I/F) 1060, an input I/F 1070, and a network I/F 1080 are connected by a bus 1090.

The arithmetic device 1030 operates based on a program stored in the primary storage device 1040 or the secondary storage device 1050, a program read from the input device 1020, or the like, and executes various types of processing. The arithmetic device 1030 is implemented by, for example, a graphics processing unit (GPU), a central processing unit (CPU), a micro processing unit (MPU), an application specific integrated circuit (ASIC), a field programmable gate array (FPGA), or the like.

The primary storage device 1040 is a memory device, such as a random access memory (RAM), that temporarily stores data used by the arithmetic device 1030 for various arithmetic operations. In addition, the secondary storage device 1050 is a storage device in which data used by the arithmetic device 1030 for various arithmetic operations and various databases are registered, and is implemented by a read only memory (ROM), a hard disk drive (HDD), a solid state drive (SSD), a flash memory, or the like. The secondary storage device 1050 may be a built-in storage or an external storage. The secondary storage device 1050 may also be a removable storage medium such as a universal serial bus (USB) memory or a secure digital (SD) memory card. The secondary storage device 1050 may also be a cloud storage (online storage), a network attached storage (NAS), a file server, or the like.

The output I/F 1060 is an interface for transmitting information to be output to the output device 1010 that outputs various types of information such as a display, a projector, and a printer, and is implemented by a connector of a standard such as a universal serial bus (USB), a digital visual interface (DVI), or a high definition multimedia interface (HDMI) (registered trademark). In addition, the input I/F 1070 is an interface for receiving information from various input devices 1020 such as a mouse, a keyboard, a keypad, a button, and a scanner, and is implemented by, for example, a USB.

In addition, the output I/F 1060 and the input I/F 1070 may be wirelessly connected to the output device 1010 and the input device 1020, respectively. In other words, the output device 1010 and the input device 1020 may be wireless equipment.

In addition, the output device 1010 and the input device 1020 may be integrated like a touch panel. In this case, the output I/F 1060 and the input I/F 1070 may also be integrated as an input-output I/F.

Note that the input device 1020 may be a device that reads information from, for example, an optical recording medium such as a compact disc (CD), a digital versatile disc (DVD), or a phase change rewritable disk (PD), a magneto-optical recording medium such as a magneto-optical disk (MO), a tape medium, a magnetic recording medium, a semiconductor memory, or the like.

The network I/F 1080 receives data from another equipment via the network N, sends the data to the arithmetic device 1030, and transmits data generated by the arithmetic device 1030 to another equipment via the network N.

The arithmetic device 1030 controls the output device 1010 and the input device 1020 via the output I/F 1060 and the input I/F 1070. For example, the arithmetic device 1030 loads a program from the input device 1020 or the secondary storage device 1050 onto the primary storage device 1040 and executes the loaded program.

For example, in a case where the computer 1000 functions as the server device 100, the arithmetic device 1030 of the computer 1000 implements the function of the control unit 130 by executing a program loaded onto the primary storage device 1040. The arithmetic device 1030 of the computer 1000 may also load a program acquired from another equipment via the network I/F 1080 onto the primary storage device 1040 and execute the loaded program. The arithmetic device 1030 of the computer 1000 may also link with another equipment via the network I/F 1080, and call and use a function of a program, data, or the like from another program of another equipment.

### 8. Others

Although the embodiments of the present application have been described above, the present invention is not limited to the contents of these embodiments. In addition, the aforementioned components include those that can be easily assumed by those skilled in the art, those that are substantially the same, and those in a so-called equivalent range. Further, the aforementioned components can be combined as appropriate. Further, various omissions, substitutions, or changes in the components can be made without departing from the gist of the aforementioned embodiments.

In addition, among the processes described in the above embodiments, all or some of the processes described as being automatically performed may be manually performed, or all or some of the processes described as being manually performed may be automatically performed by a known method. In addition, the processing procedures, specific names, and information including various types of data and parameters illustrated in the above document and drawings can be arbitrarily changed unless otherwise specified. For example, the various types of information illustrated in the drawings are not limited to the illustrated information.

In addition, the components of each of the devices illustrated in the drawings are functionally conceptual, and are not necessarily physically configured as illustrated in the drawings. In other words, specific forms of distribution and integration of each of the devices are not limited to those illustrated in the drawings, and all or some of the devices may be configured to be functionally or physically distributed or integrated in arbitrary units according to various loads, usage conditions, and the like.

For example, the above-described server device 100 may be implemented by a plurality of server computers, or may be implemented by calling an external platform or the like by an application programming interface (API), network computing, or the like depending on the function, and the configuration thereof can be flexibly changed.

In addition, the above-described embodiments and the modification can be appropriately combined to the extent that the processing contents do not contradict each other.

In addition, the “section, module, or unit” described above can be replaced with a “means”, “circuit”, or the like. For example, the acquisition unit can be replaced with an acquisition means or an acquisition circuit.

According to an aspect of the embodiment, it is possible to appropriately propose a service to a business operator.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
an acquisition unit that acquires business operator information of a business operator;
an estimation unit that estimates a proposal service to be proposed from among a plurality of services based on the business operator information;
a generation unit that generates explanatory content describing a use mode when the business operator uses the proposal service; and
a provision unit that provides the explanatory content.

2. The information processing device according to claim 1, wherein
the estimation unit estimates the proposal service having high similarity to business operator information by using a learning model that has learned a set of the business operator information, characteristics before and after provision of a past service, and a budget of the past service.

3. The information processing device according to claim 1, wherein
the estimation unit proposes switching of a service already being performed by the business operator.

4. The information processing device according to claim 1, wherein
the estimation unit estimates whether or not sales of the business operator will be reduced, and estimates the proposal service.

5. The information processing device according to claim 2, wherein
the generation unit inputs the business operator information and a function and an explanation of the proposal service in the business operator to a GPT and generates the explanatory content.

6. The information processing device according to claim 5, wherein
the generation unit generates the explanatory content in consideration of a service already being performed by the business operator.

7. The information processing device according to claim 1, wherein
the provision unit provides a unified management system for setting and confirming a service of the business operator, and provides the explanatory content via the unified management system.

8. The information processing device according to claim 1, wherein
the provision unit provides the explanatory content to the business operator by mail.

9. An information processing method executed by an information processing device, the information processing method comprising:
an acquisition step of acquiring business operator information of a business operator;
a proposal step of proposing a proposal service to be proposed from among a plurality of services based on the business operator information;
a generation step of generating explanatory content describing a use mode when the business operator uses the proposal service; and
a provision step of providing the generated explanatory content.

10. A non-transitory computer readable storage medium registered an information processing program causing a computer to execute:
an acquisition procedure of acquiring business operator information of a business operator;
a proposal procedure of proposing a proposal service to be proposed from among a plurality of services based on the business operator information;
a generation procedure of generating explanatory content describing a use mode when the business operator uses the proposal service; and
a provision procedure of providing the generated explanatory content.
